(19) United States
(12) Patent Application Publication
(10) Pub. No.: US 2015/0260950 A1
(43) Pub. Date: Sep. 17, 2015

(54) OPTICAL IMAGING LENS AND ELETRONIC DEVICE COMPRISING THE SAME

(71) Applicants: Shih-Han Chen, Taichung City (TW); Chia-Cheng Lin, Taichung City (TW); Long Ye, Taichung City (TW)

(72) Inventors: Shih-Han Chen, Taichung City (TW); Chia-Cheng Lin, Taichung City (TW); Long Ye, Taichung City (TW)

(21) Appl. No.: 14/506,695

(22) Filed: Oct. 6, 2014

(30) Foreign Application Priority Data
Mar. 13, 2014 (CN) 201410092117.7

(51) Int. Cl. G02B 9/34; H04N 5/225; G02B 13/00

(52) U.S. Cl. CPC G02B 9/34; G02B 13/0015; H04N 5/2252; H04N 5/2254; H04N 5/2253

(57) ABSTRACT

An optical imaging lens set, including: a first lens element having an object-side surface with a convex part in a vicinity of the optical axis, and with a convex part in a vicinity of its periphery, a second lens element with negative refractive power, a third lens element with positive refractive power, having an object-side surface with a concave part in a vicinity of its periphery, and having an image-side surface with a convex part in a vicinity of the optical axis, a fourth lens element having an object-side surface with a convex part in a vicinity of its periphery, and having an image-side surface with a concave part in a vicinity of the optical axis, and a convex part in a vicinity of its periphery.

### BACKGROUND OF THE INVENTION

1. Field of the Invention

The present invention generally relates to an optical imaging lens set and an electronic device which includes such optical imaging lens set. Specifically speaking, the present invention is directed to an optical imaging lens set of four lens elements and an electronic device which includes such optical imaging lens set.

2. Description of the Prior Art

Applications of small photographic devices such as mobile phones have gradually developed recently. Those photographic devices have considerable demands of short total length, and therefore, how to reduce the total length of a photographic device is an important research objective.

U.S. Pat. No. 8,199,416 and U.S. Pat. No. 8,351,135 both disclosed an optical imaging lens set of four lens elements, however, in those patents mentioned above, the second lens element has positive refractive power, and the third lens element has negative refractive power. This arrangement may possibly cause the total length of the optical imaging lens set to become too long, and hardly satisfies the miniaturization requirements of the optical imaging lens set.

Therefore, how to reduce the total length of a photographic device, but still maintain good optical performance, is an important research objective.

### SUMMARY OF THE INVENTION

In light of the above, the present invention proposes an optical imaging lens set that is lightweight, has shorter total length, has a low production cost, has an enlarged half of field of view, has a high resolution and has high image quality. The optical imaging lens set of four lens elements of the present invention has a first lens element, an aperture stop, a second lens element, a third lens element and a fourth lens element sequentially from an object side to an image side along an optical axis.

The present invention provides an optical imaging lens set, from an object side toward an image side in order along an optical axis comprising: a first lens element, an aperture stop, a second lens element, a third lens element and a fourth lens element, the first lens element having an object-side surface with a convex part in a vicinity of the optical axis, and with a convex part in a vicinity of its periphery, the second lens element with negative refractive power, the third lens element with positive refractive power, having an object-side surface with a concave part in a vicinity of its periphery, and having an image-side surface with a convex part in a vicinity of the optical axis, the fourth lens element having an object-side surface with a convex part in a vicinity of its periphery, and having an image-side surface with a concave part in a vicinity of the optical axis, and a convex part in a vicinity of its periphery, wherein the optical imaging lens set does not include any lens element with refractive power other than said first, second, third and fourth lens elements.

In the optical imaging lens set of four lens elements of the present invention, an air gap AG12 along the optical axis is disposed between the first lens element and the second lens element, an air gap AG23 along the optical axis is disposed between the second lens element and the third lens element, an air gap AG34 along the optical axis is disposed between the third lens element and the fourth lens element, and the sum of total three air gaps between adjacent lens elements from the first lens element to the fourth lens element along the optical axis is AAG=AG12+AG23+AG34.

In the optical imaging lens set of four lens elements of the present invention, the first lens element has a first lens element thickness T1 along the optical axis, the second lens element has a second lens element thickness T2 along the optical axis, the third lens element has a third lens element thickness T3 along the optical axis, the fourth lens element has a fourth lens element thickness T4 along the optical axis, and the total thickness of all the lens elements in the optical imaging lens set along the optical axis is ALT=T1+T2+T3+T4. In addition, the distance BFL between the image-side surface of the fourth lens element to an image plane along the optical axis.

In the optical imaging lens set of four lens elements of the present invention, the relationship BFL/AAG≦2.0 is satisfied.

In the optical imaging lens set of four lens elements of the present invention, the relationship (AG12+AG34)/T2≦1 is satisfied.

In the optical imaging lens set of four lens elements of the present invention, the relationship 1.6≦T4/T2 is satisfied.

In the optical imaging lens set of four lens elements of the present invention, the relationship 1.3≦AAG/T1 is satisfied.

In the optical imaging lens set of four lens elements of the present invention, the relationship T3/T4≦1.2 is satisfied.

In the optical imaging lens set of four lens elements of the present invention, the relationship T3/AAG≦0.95 is satisfied.

In the optical imaging lens set of four lens elements of the present invention, the relationship AAG/T4≦1.7 is satisfied.

In the optical imaging lens set of four lens elements of the present invention, the relationship 3.45≦ALT/T1 is satisfied.

In the optical imaging lens set of four lens elements of the present invention, the relationship ALT/T4≦3.8 is satisfied.

In the optical imaging lens set of four lens elements of the present invention, the relationship 2.7≦AAG/T2 is satisfied.

In the optical imaging lens set of four lens elements of the present invention, the relationship 7.0≦ALT/(AG12+AG34) is satisfied.

In the optical imaging lens set of four lens elements of the present invention, the relationship 3.0≦AAG/(AG12+AG34) is satisfied.

The present invention also proposes an electronic device which includes the optical imaging lens set as described above. The electronic device includes a case and an image module disposed in the case. The image module includes an optical imaging lens set as described above, a barrel for the installation of the optical imaging lens set, a module housing unit for the installation of the barrel, a substrate for the installation of the module housing unit, and an image sensor disposed on the substrate and at an image side of the optical imaging lens set.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a first example of the optical imaging lens set of the present invention.

FIG. 2A illustrates the longitudinal spherical aberration on the image plane of the first example.

FIG. 2B illustrates the astigmatic aberration on the sagittal direction of the first example.

FIG. 2C illustrates the astigmatic aberration on the tangential direction of the first example.

FIG. 2D illustrates the distortion aberration of the first example.

FIG. 3 illustrates a second example of the optical imaging lens set of four lens elements of the present invention.

FIG. 4A illustrates the longitudinal spherical aberration on the image plane of the second example.

FIG. 4B illustrates the astigmatic aberration on the sagittal direction of the second example.

FIG. 4C illustrates the astigmatic aberration on the tangential direction of the second example.

FIG. 4D illustrates the distortion aberration of the second example.

FIG. 5 illustrates a third example of the optical imaging lens set of four lens elements of the present invention.

FIG. 6A illustrates the longitudinal spherical aberration on the image plane of the third example.

FIG. 6B illustrates the astigmatic aberration on the sagittal direction of the third example.

FIG. 6C illustrates the astigmatic aberration on the tangential direction of the third example.

FIG. 6D illustrates the distortion aberration of the third example.

FIG. 7 illustrates a fourth example of the optical imaging lens set of four lens elements of the present invention.

FIG. 8A illustrates the longitudinal spherical aberration on the image plane of the fourth example.

FIG. 8B illustrates the astigmatic aberration on the sagittal direction of the fourth example.

FIG. 8C illustrates the astigmatic aberration on the tangential direction of the fourth example.

FIG. 8D illustrates the distortion aberration of the fourth example.

FIG. 9 illustrates a fifth example of the optical imaging lens set of four lens elements of the present invention.

FIG. 10A illustrates the longitudinal spherical aberration on the image plane of the fifth example.

FIG. 10B illustrates the astigmatic aberration on the sagittal direction of the fifth example.

FIG. 10C illustrates the astigmatic aberration on the tangential direction of the fifth example.

FIG. 10D illustrates the distortion aberration of the fifth example.

FIG. 11 illustrates a sixth example of the optical imaging lens set of four lens elements of the present invention.

FIG. 12A illustrates the longitudinal spherical aberration on the image plane of the sixth example.

FIG. 12B illustrates the astigmatic aberration on the sagittal direction of the sixth example.

FIG. 12C illustrates the astigmatic aberration on the tangential direction of the sixth example.

FIG. 12D illustrates the distortion aberration of the sixth example.

FIG. 13 illustrates exemplificative shapes of the optical imaging lens element of the present invention.

FIG. 14 illustrates a first preferred example of the portable electronic device with an optical imaging lens set of the present invention.

FIG. 15 illustrates a second preferred example of the portable electronic device with an optical imaging lens set of the present invention.

FIG. 16 shows the optical data of the first example of the optical imaging lens set.

FIG. 17 shows the aspheric surface data of the first example.

FIG. 18 shows the optical data of the second example of the optical imaging lens set.

FIG. 19 shows the aspheric surface data of the second example.

FIG. 20 shows the optical data of the third example of the optical imaging lens set.

FIG. 21 shows the aspheric surface data of the third example.

FIG. 22 shows the optical data of the fourth example of the optical imaging lens set.

FIG. 23 shows the aspheric surface data of the fourth example.

FIG. 24 shows the optical data of the fifth example of the optical imaging lens set.

FIG. 25 shows the aspheric surface data of the fifth example.

FIG. 26 shows the optical data of the sixth example of the optical imaging lens set.

FIG. 27 shows the aspheric surface data of the sixth example.

FIG. 28 shows some important ratios in the examples.

### DETAILED DESCRIPTION

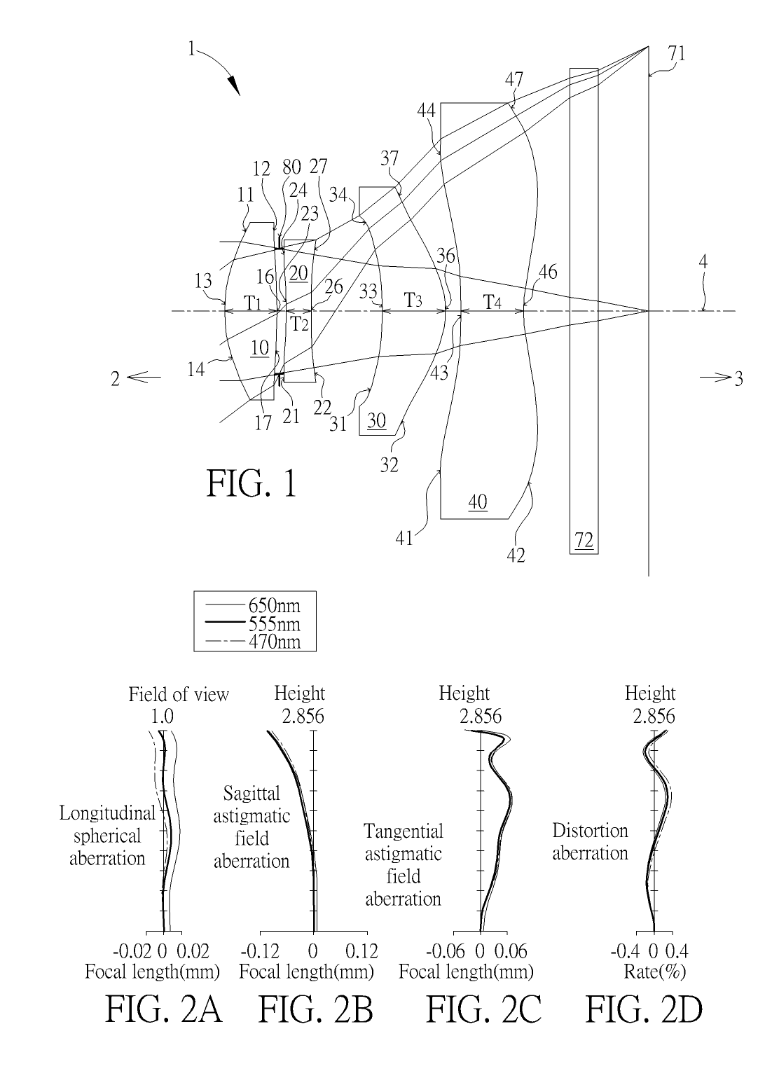

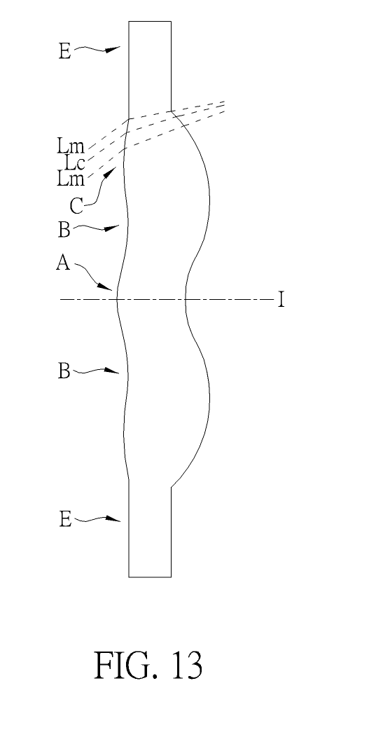

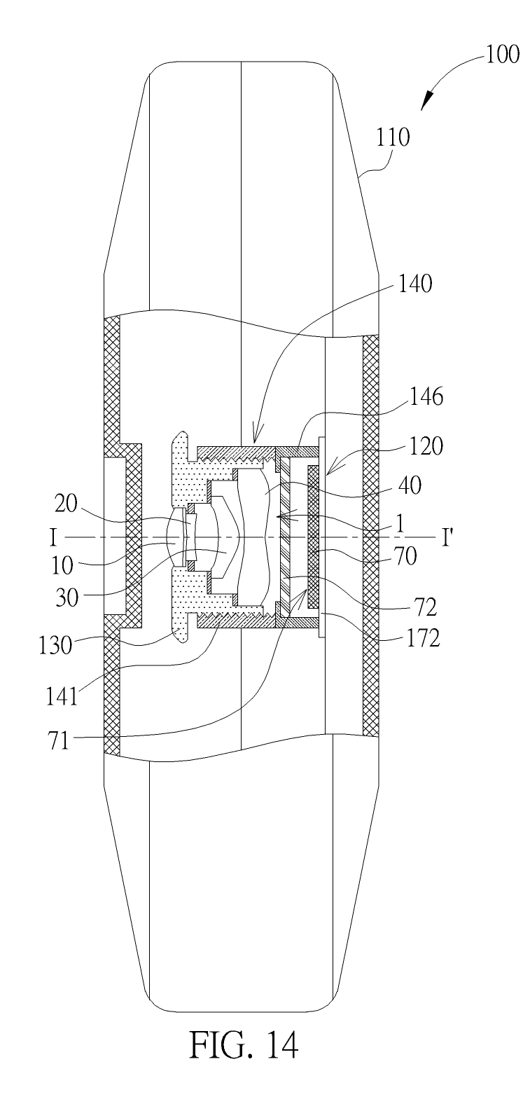

Before the detailed description of the present invention, the first thing to be noticed is that in the present invention, similar (not necessarily identical) elements are labeled as the same numeral references. In the entire present specification, “a certain lens element has negative/positive refractive power” refers to the part in a vicinity of the optical axis of the lens element has negative/positive refractive power. “An object-side/image-side surface of a certain lens element has a concave/convex part” refers to the part is more concave/convex in a direction parallel with the optical axis to be compared with an outer region next to the region. Taking FIG. 13 for example, the optical axis is “I” and the lens element is symmetrical with respect to the optical axis I. The object side of the lens element has a convex part in the region A, a concave part in the region B, and a convex part in the region C because region A is more convex in a direction parallel with the optical axis than an outer region (region B) next to region A, region B is more concave than region C and region C is similarly more convex than region E. “A circular periphery of a certain lens element” refers to a circular periphery region of a surface on the lens element for light to pass through, that is, region C in the drawing. In the drawing, imaging light includes Lc (chief ray) and Lm (marginal ray). “A vicinity of the optical axis” refers to an optical axis region of a surface on the lens element for light to pass through, that is, the region A in FIG. 13. In addition, the lens element may include an extension part E for the lens element to be installed in an optical imaging lens set. Ideally speaking, no light would pass through the extension part, and the actual structure and shape of the extension part is not limited to this and may have other variations. For the reason of simplicity, the extension part is not illustrated in FIGS. 1, 3, 5, 7, 9 and 11.

As shown in FIG. 1, the optical imaging lens set 1 of fourth lens elements of the present invention, sequentially located from an object side 2 (where an object is located) to an image side 3 along an optical axis 4, has a first lens element 10, an aperture stop 80, a second lens element 20, a third lens element 30, a fourth lens element 40, a filter 72 and an image plane 71. Generally speaking, the first lens element 10, the second lens element 20, the third lens element 30 and the fourth lens element 40 maybe made of a transparent plastic material and each has an appropriate refractive power, but the present invention is not limited to this. There are exclusively fourth lens elements with refractive power in the optical imaging lens set 1 of the present invention. The optical axis 4 is the optical axis of the entire optical imaging lens set 1, and the optical axis of each of the lens elements coincides with the optical axis of the optical imaging lens set 1.

Furthermore, the optical imaging lens set 1 includes an aperture stop (ape. stop) 80 disposed in an appropriate position. In FIG. 1, the aperture stop 80 is disposed between the first lens element 10 and the second lens element 20. When light emitted or reflected by an object (not shown) which is located at the object side 2 enters the optical imaging lens set 1 of the present invention, it forms a clear and sharp image on the image plane 71 at the image side 3 after passing through the first lens element 10, the aperture stop 80, the second lens element 20, the third lens element 30, the fourth lens element 40 and the filter 72.

In the embodiments of the present invention, the optional filter 72 maybe a filter of various suitable functions, for example, the filter 72 may be an infrared cut filter (IR cut filter), placed between the fourth lens element 40 and the image plane 71. The filter 72 is made of glass, without affecting the focal length of the optical lens element system, namely the optical imaging lens set, of the present invention.

Each lens element in the optical imaging lens set 1 of the present invention has an object-side surface facing toward the object side 2 as well as an image-side surface facing toward the image side 3. In addition, each object-side surface and image-side surface in the optical imaging lens set 1 of the present invention has a part in a vicinity of its circular periphery (circular periphery part) away from the optical axis 4 as well as a part in a vicinity of the optical axis (optical axis part) close to the optical axis 4. For example, the first lens element 10 has a first object-side surface 11 and a first image-side surface 12; the second lens element 20 has a second object-side surface 21 and a second image-side surface 22; the third lens element 30 has a third object-side surface 31 and a third image-side surface 32; and the fourth lens element 40 has a fourth object-side surface 41 and a fourth image-side surface 42.

Each lens element in the optical imaging lens set 1 of the present invention further has a central thickness on the optical axis 4. For example, the first lens element 10 has a first lens element thickness T1, the second lens element 20 has a second lens element thickness T2, the third lens element 30 has a third lens element thickness T3, and the fourth lens element 40 has a fourth lens element thickness T4. Therefore, the total thickness of all the lens elements in the optical imaging lens set 1 along the optical axis 4 is ALT=T1+T2+T3+T4.

In addition, between two adjacent lens elements in the optical imaging lens set 1 of the present invention there is an air gap along the optical axis 4. For example, an air gap AG12 is disposed between the first lens element 10 and the second lens element 20, an air gap AG23 is disposed between the second lens element 20 and the third lens element 30, and an air gap AG34 is disposed between the third lens element 30 and the fourth lens element 40. Therefore, the sum of total three air gaps between adjacent lens elements from the first lens element 10 to the fourth lens element 40 along the optical axis 4 is AAG=AG12+AG23+AG34.

Besides, the distance between the fourth image-side surface 42 of the fourth lens element 40 to the image plane 71 along the optical axis 4 is BFL.

### FIRST EXAMPLE

Please refer to FIG. 1 which illustrates the first example of the optical imaging lens set 1 of the present invention. Please refer to FIG. 2A for the longitudinal spherical aberration on the image plane 71 of the first example; please refer to FIG. 2B for the astigmatic field aberration on the sagittal direction; please refer to FIG. 2C for the astigmatic field aberration on the tangential direction, and please refer to FIG. 2D for the distortion aberration. The Y axis of the spherical aberration in each example is “field of view” for 1.0. The Y axis of the astigmatic field and the distortion in each example stand for “image height”. The image height is 2.856 mm.

The optical imaging lens set 1 of the first example has four lens elements 10 to 40; all of the lens elements are made of a plastic material and have refractive power. The optical imaging lens set 1 also has an aperture stop 80, a filter 72, and an image plane 71. The aperture stop 80 is provided between the first lens element 10 and the second lens element 20. The filter 72 may be an infrared filter (IR cut filter) to prevent inevitable infrared light from reaching the image plane to adversely affect the imaging quality.

The first lens element 10 has positive refractive power. The first object-side surface 11 facing toward the object side 2 is a convex surface, having a convex part 13 in the vicinity of the optical axis and a convex part 14 in a vicinity of its circular periphery; The first image-side surface 12 facing toward the image side 3 is a convex surface, having a convex part 16 in the vicinity of the optical axis and a convex part 17 in a vicinity of its circular periphery.

The second lens element 20 has negative refractive power. The second object-side surface 21 facing toward the object side 2 is a concave surface, having a concave part 23 in the vicinity of the optical axis and a concave part 24 in a vicinity of its circular periphery; The second image-side surface 22 facing toward the image side 3 is a concave surface, having a concave part 26 in the vicinity of the optical axis and a concave part 27 in a vicinity of its circular periphery.

The third lens element 30 has positive refractive power. The third object-side surface 31 facing toward the object side 2 is a concave surface, having a concave part 33 in the vicinity of the optical axis and a concave part 34 in a vicinity of its circular periphery; The third image-side surface 32 facing toward the image side 3 is a convex surface, having a convex part 36 in the vicinity of the optical axis and a convex part 37 in a vicinity of its circular periphery.

The fourth lens element 40 has negative refractive power. The fourth object-side surface 41 facing toward the object side 2, has a concave part 43 in the vicinity of the optical axis and a convex part 44 in a vicinity of its circular periphery; The fourth image-side surface 42 facing toward the image side 3, has a concave part 46 in the vicinity of the optical axis and a convex part 47 in a vicinity of its circular periphery. The filter 72 may be disposed between the fourth lens element 40 and the image plane 71.

In the optical imaging lens element 1 of the present invention, the object-side surfaces 11/21/31/41 and image-side surfaces 12/22/32/42 are all aspherical. These aspheric coefficients are defined according to the following formula:

$$Z ( Y ) = \frac{{Y}^{2}}{R} / ( 1 + \sqrt{1 - ( 1 + K ) \frac{{Y}^{2}}{R}} ) + {\sum }_{i = 1}^{n} {a}_{2 i} \times {Y}^{2 i}$$

In which:

R represents the curvature radius of the lens element surface;

Z represents the depth of an aspherical surface (the perpendicular distance between the point of the aspherical surface at a distance Y from the optical axis and the tangent plane of the vertex on the optical axis of the aspherical surface);

Y represents a vertical distance from a point on the aspherical surface to the optical axis;

K is a conic constant;

a₂ᵢ is the aspheric coefficient of the 2i order.

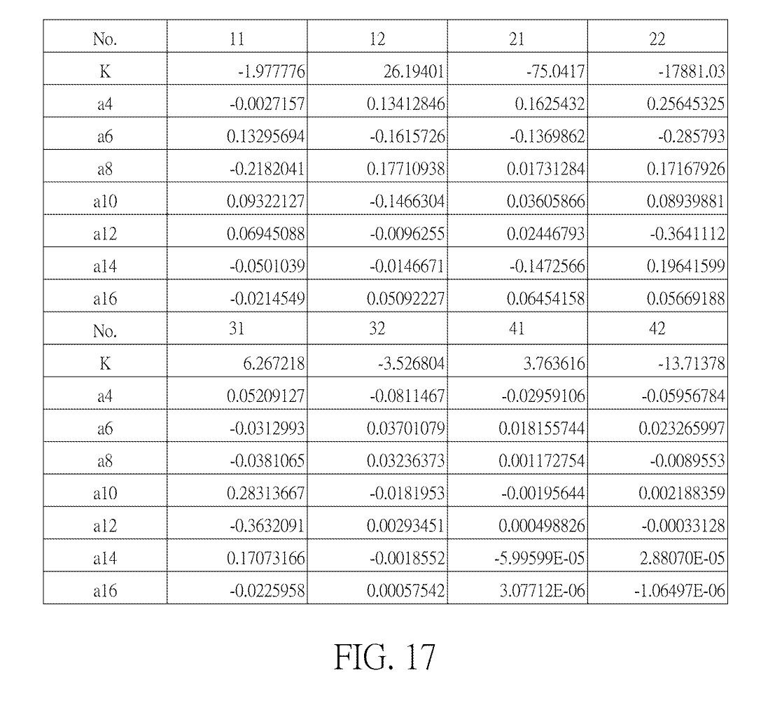

The optical data of the first example of the optical imaging lens set 1 are shown in FIG. 16 while the aspheric surface data are shown in FIG. 17. In the present examples of the optical imaging lens set, the f-number of the entire optical lens element system is Fno, HFOV stands for the half field of view which is half of the field of view of the entire optical lens element system, and the unit for the curvature radius, the thickness and the focal length is in millimeters (mm). The length of the optical imaging lens set (the distance from the first object-side surface 11 of the first lens element 10 to the image plane 71 is 4.555 mm. The image height is 2.856 mm, HFOV is 46.26 degrees. Some important ratios of the first example are as follows:

ALT=2.170

AAG=1.037

BFL=1.348

BFL/AAG=1.300

AG12+34T2=1.000

T3/AAG=0.647

T3/T4=1.000

T4/T2=2.486

AAG/T1=1.860

AAG/T4=1.545

ALT/T1=3.893

ALT/T4=3.233

AAG/T2=3.841

ALT/AG12+34=8.037

AAG/AG12+34=3.841

### SECOND EXAMPLE

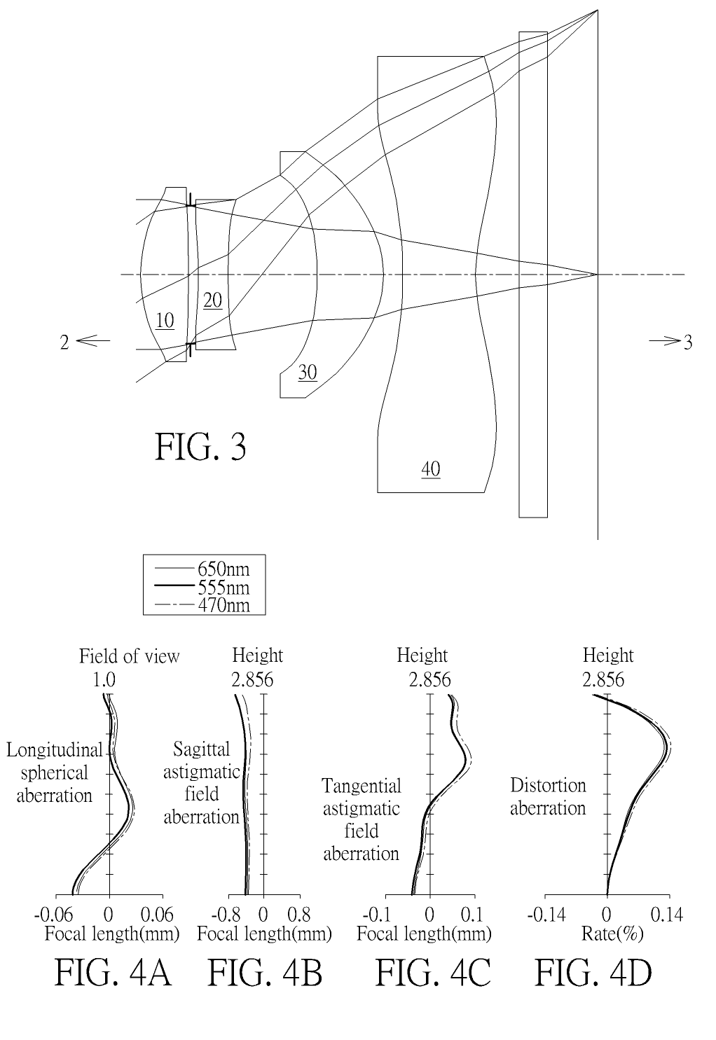

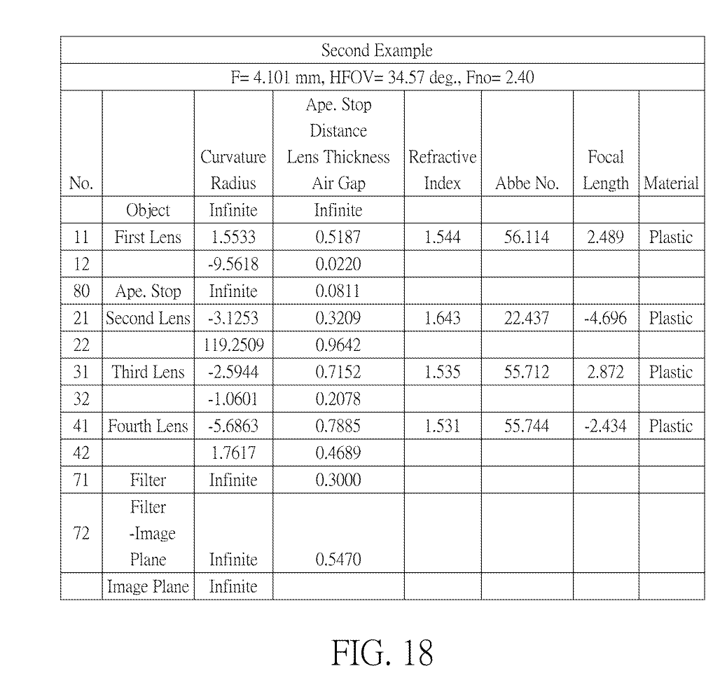

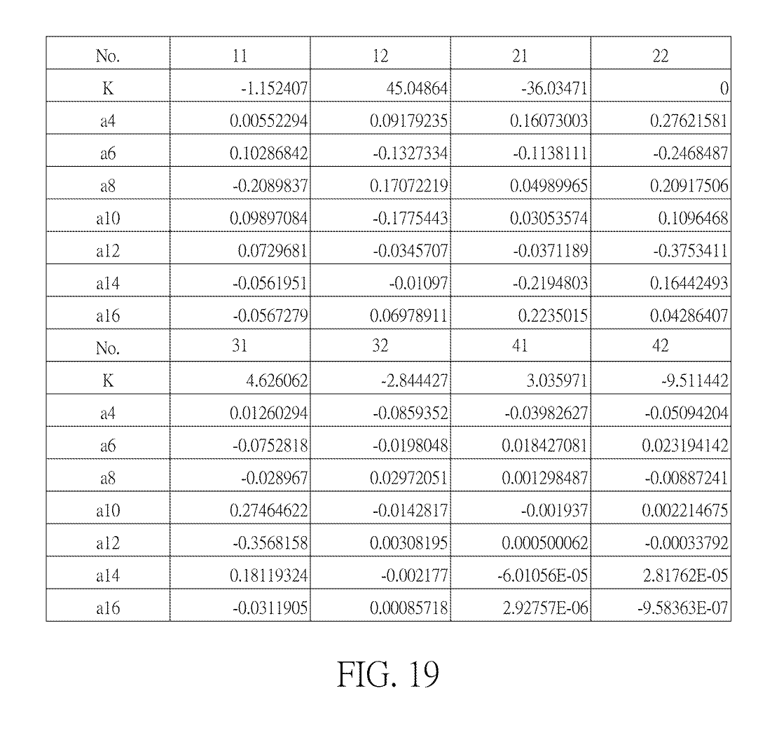

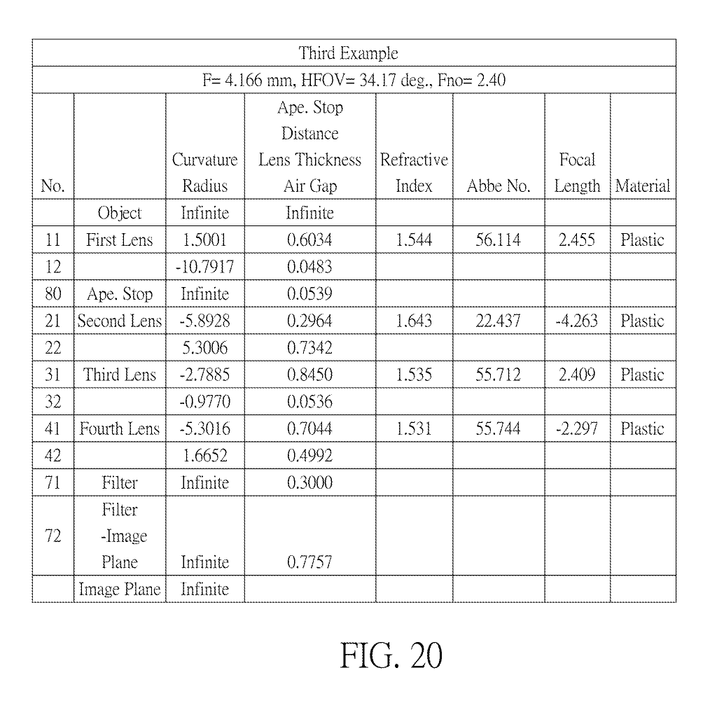

Please refer to FIG. 3 which illustrates the second example of the optical imaging lens set 1 of the present invention. Please refer to FIG. 4A for the longitudinal spherical aberration on the image plane 71 of the second example; please refer to FIG. 4B for the astigmatic aberration on the sagittal direction; please refer to FIG. 4C for the astigmatic aberration on the tangential direction, and please refer to FIG. 4D for the distortion aberration. The components in the second example are similar to those in the first example, but the optical data such as the curvature radius, the refractive power, the lens thickness, the lens focal length, the aspheric surface or the back focal length in this example are different from the optical data in the first example. The optical data of the second example of the optical imaging lens set are shown in FIG. 18 while the aspheric surface data are shown in FIG. 19. The length of the optical imaging lens set is 4.934 mm. The image height is 2.856 mm, HFOV is 34.57 degrees. Some important ratios of the second example are as follows:

ALT=2.343

AAG=1.275

BFL=1.316

BFL/AAG=1.032

AG12+34/T2=0.969

T3/AAG=0.561

T3/T4=0.907

T4/T2=2.457

AAG/T1=2.458

AAG/T4=1.617

ALT/T1=4.518

ALT/T4=2.972

AAG/T2=3.973

ALT/AG12+34=7.539

AAG/AG12+34=4.102

### THIRD EXAMPLE

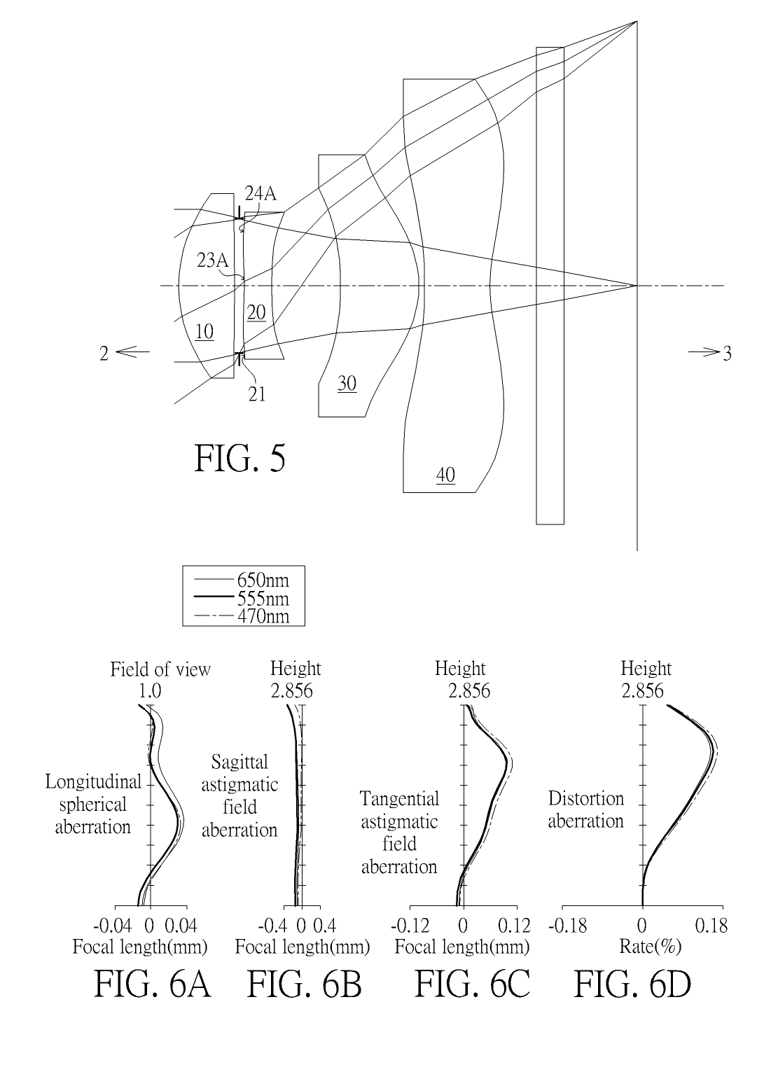

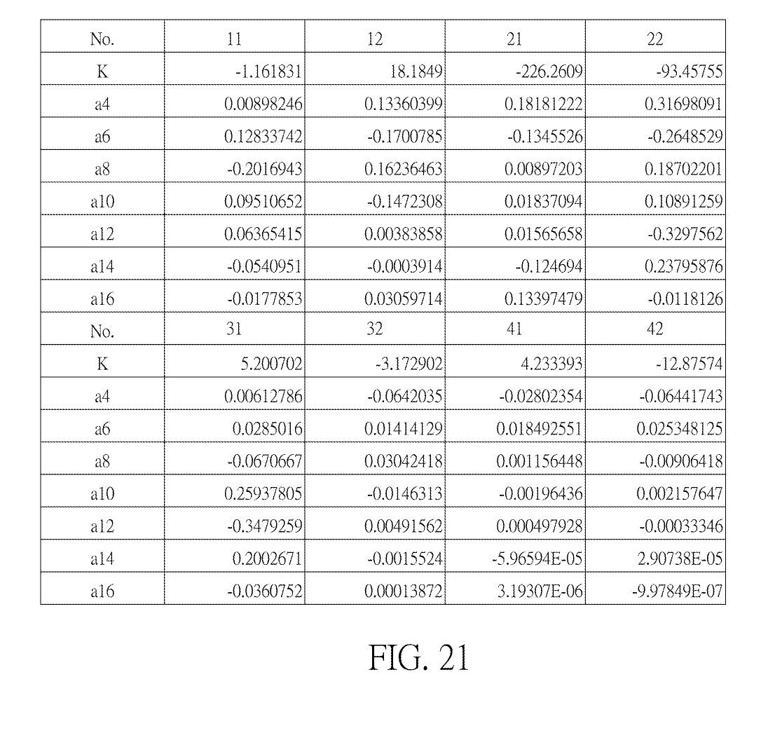

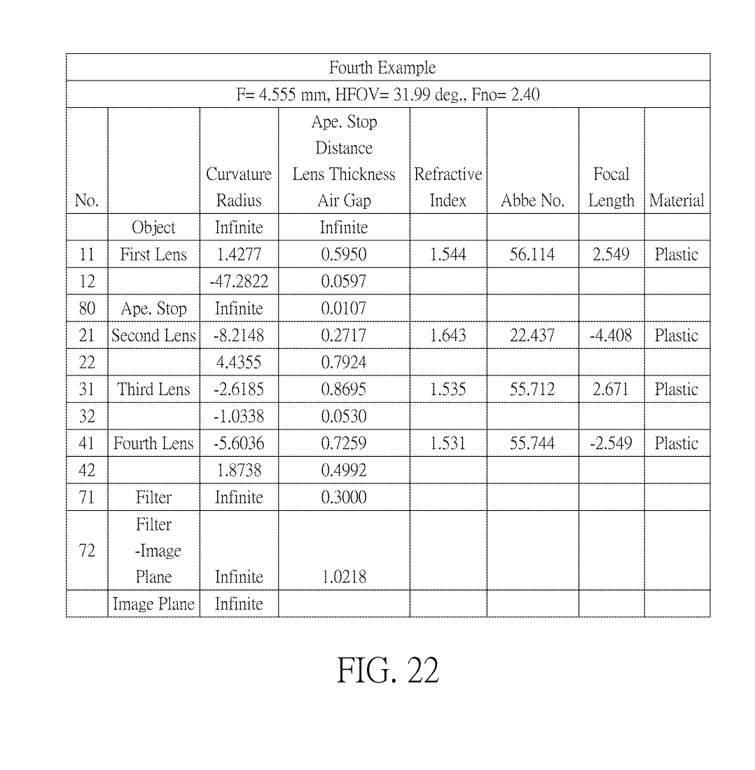

Please refer to FIG. 5 which illustrates the third example of the optical imaging lens set 1 of the present invention. Please refer to FIG. 6A for the longitudinal spherical aberration on the image plane 71 of the third example; please refer to FIG. 6B for the astigmatic aberration on the sagittal direction; please refer to FIG. 6C for the astigmatic aberration on the tangential direction, and please refer to FIG. 6D for the distortion aberration. The components in the third example are similar to those in the first example, but the optical data such as the curvature radius, the refractive power, the lens thickness, the lens focal length, the aspheric surface or the back focal length in this example are different from the optical data in the first example, and in this example, the second object-side surface 21 of the second lens element 20 has a concave part 23A in the vicinity of the optical axis and a convex part 24A in a vicinity of its circular periphery. The optical data of the third example of the optical imaging lens set are shown in FIG. 21 while the aspheric surface data are shown in FIG. 22. The length of the optical imaging lens set is 4.914 mm. The image height is 2.856 mm, HFOV is 34.17 degrees. Some important ratios of the third example are as follows:

ALT=2.449

AAG=0.890

BFL=1.575

BFL/AAG=1.770

AG12+34/T2=0.526

T3/AAG=0.949

T3/T4=1.200

T4/T2=2.377

AAG/T1=1.475

AAG/T4=1.264

ALT/T1=4.059

ALT/T4=3.477

AAG/T2=3.003

ALT/AG12+34=15.716

AAG/AG12+34=5.711

### FOURTH EXAMPLE

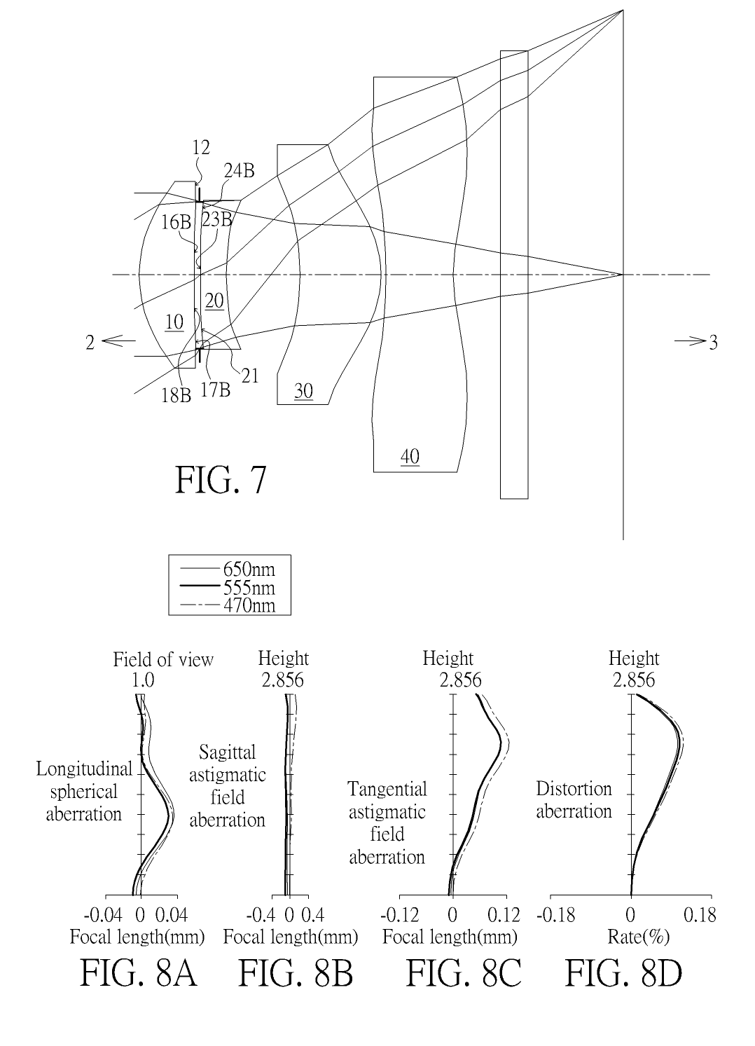

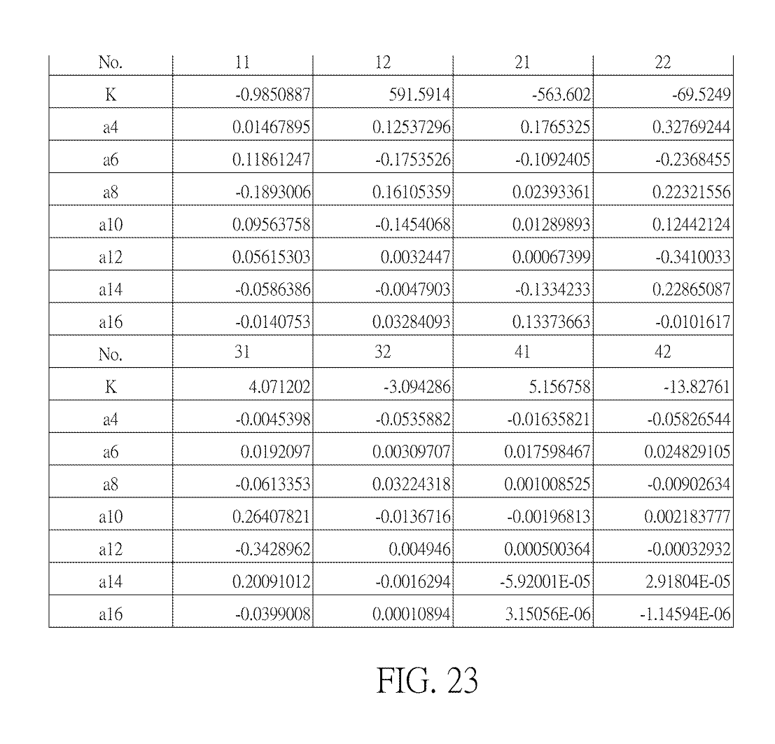

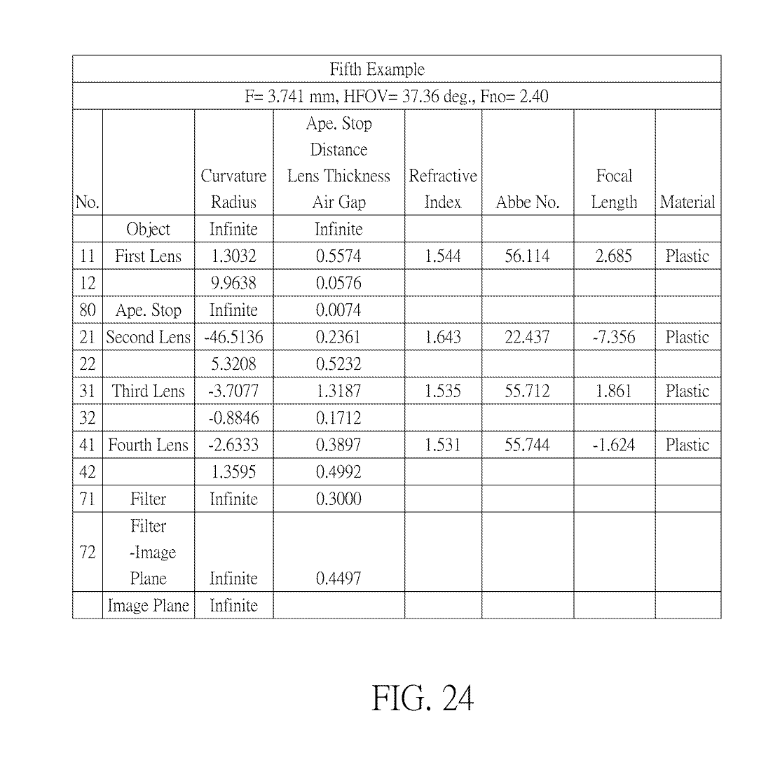

Please refer to FIG. 7 which illustrates the fourth example of the optical imaging lens set 1 of the present invention. Please refer to FIG. 8A for the longitudinal spherical aberration on the image plane 71 of the fourth example; please refer to FIG. 8B for the astigmatic aberration on the sagittal direction; please refer to FIG. 8C for the astigmatic aberration on the tangential direction, and please refer to FIG. 8D for the distortion aberration. The components in the fourth example are similar to those in the first example, but the optical data such as the curvature radius, the refractive power, the lens thickness, the lens focal length, the aspheric surface or the back focal length in this example are different from the optical data in the first example, and in this example, the first image-side surface 12 of the first lens element 10 has a convex part 16B in the vicinity of the optical axis and a convex part 17B in a vicinity of its circular periphery as well as a concave part 18B between the optical axis and the circular periphery; the second object-side surface 21 of the second lens element 20 has a concave part 23B in the vicinity of the optical axis and a convex part 24B in a vicinity of its circular periphery. The optical data of the fourth example of the optical imaging lens set are shown in FIG. 22 while the aspheric surface data are shown in FIG. 23. The length of the optical imaging lens set is 5.199 mm. The image height is 2.856 mm, HFOV is 31.99 degrees. Some important ratios of the fourth example are as follows:

ALT=2.462

AAG=0.916

BFL=1.821

BFL/AAG=1.989

AG12+34/T2=0.454

T3/AAG=0.949

T3/T4=1.198

T4/T2=2.672

AAG/T1=1.539

AAG/T4=1.261

ALT/T1=4.138

ALT/T4=3.392

AAG/T2=3.371

ALT/AG12+34=19.957

AAG/AG12+34 32 7.423

### FIFTH EXAMPLE

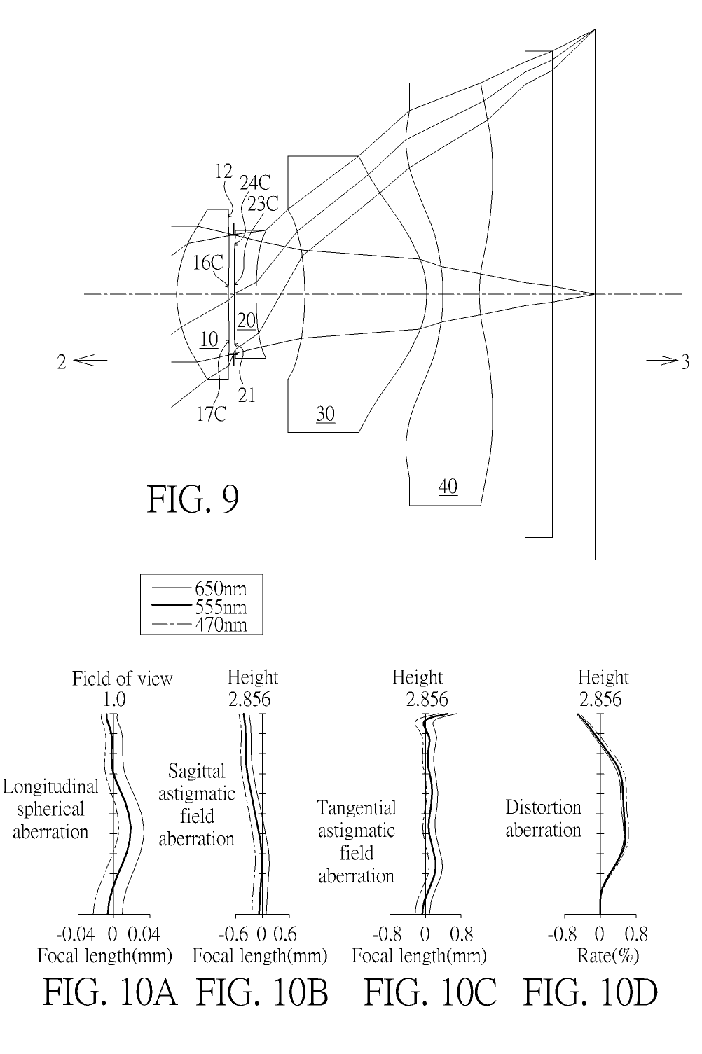

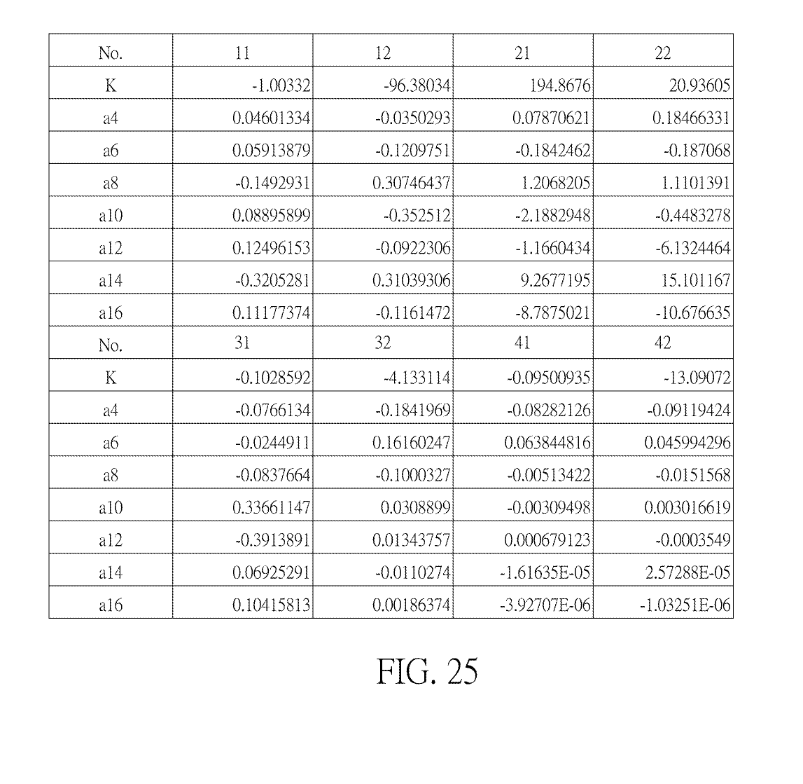

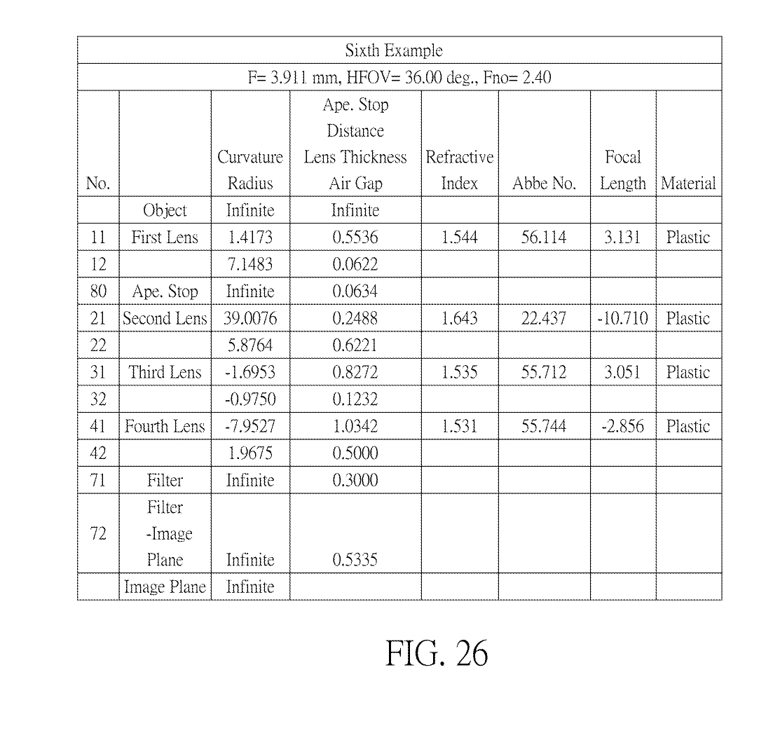

Please refer to FIG. 9 which illustrates the fifth example of the optical imaging lens set 1 of the present invention. Please refer to FIG. 10A for the longitudinal spherical aberration on the image plane 71 of the fifth example; please refer to FIG. 10B for the astigmatic aberration on the sagittal direction; please refer to FIG. 10C for the astigmatic aberration on the tangential direction, and please refer to FIG. 10D for the distortion aberration. The components in the fifth example are similar to those in the first example, but the optical data such as the curvature radius, the refractive power, the lens thickness, the lens focal length, the aspheric surface or the back focal length in this example are different from the optical data in the first example, and in this example, the first image-side surface 12 of the first lens element 10 has a concave part 16C in the vicinity of the optical axis and a convex part 17C in a vicinity of its circular periphery; the second object-side surface 21 of the second lens element 20 has a concave part 23C in the vicinity of the optical axis and a convex part 24C in a vicinity of its circular periphery. The optical data of the fifth example of the optical imaging lens set are shown in FIG. 24 while the aspheric surface data are shown in FIG. 25. The length of the optical imaging lens set is 4.510 mm. The image height is 2.856 mm, HFOV is 37.36 degrees. Some important ratios of the fifth example are as follows:

ALT=2.502

AAG=0.759

BFL=1.249

BFL/AAG=1.645

AG12+34/T2=1.000

T3/AAG=1.737

T3/T4=3.384

T4/T2=1.650

AAG/T1=1.362

AAG/T4=1.949

ALT/T1=4.489

ALT/T4=6.421

AAG/T2=3.216

ALT/AG12+34=10.594

AAG/AG12+34=3.215

### SIXTH EXAMPLE

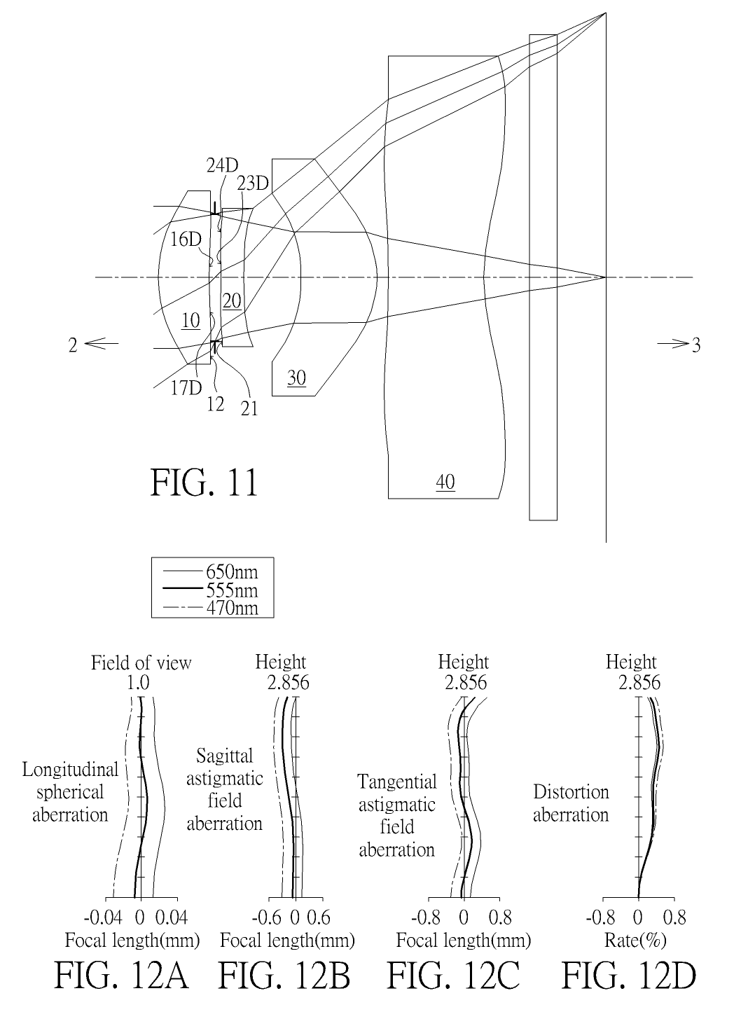

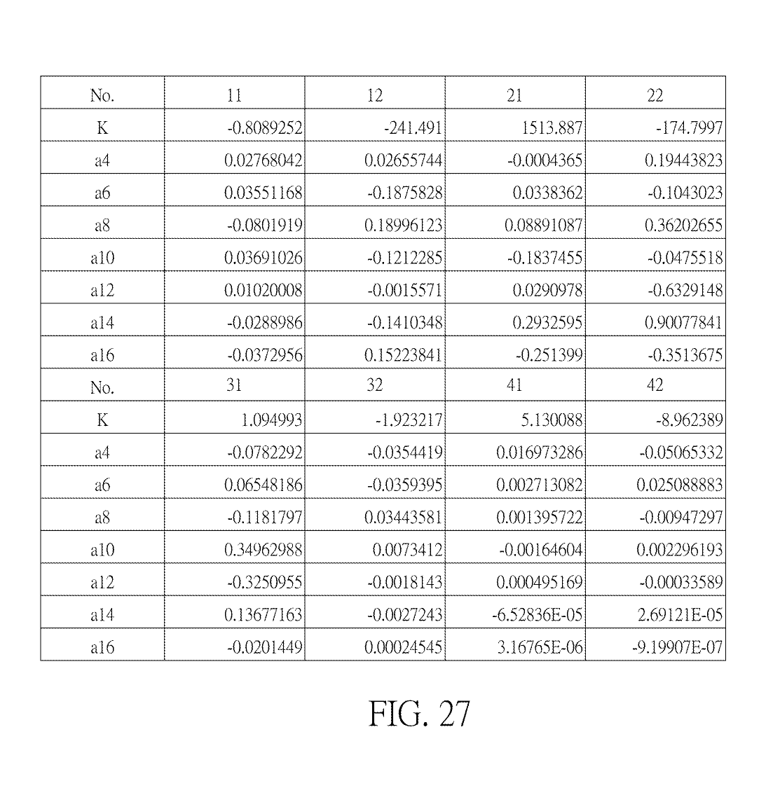

Please refer to FIG. 11 which illustrates the sixth example of the optical imaging lens set 1 of the present invention. Please refer to FIG. 12A for the longitudinal spherical aberration on the image plane 71 of the sixth example; please refer to FIG. 12B for the astigmatic aberration on the sagittal direction; please refer to FIG. 12C for the astigmatic aberration on the tangential direction, and please refer to FIG. 12D for the distortion aberration. The components in the sixth example are similar to those in the first example, but the optical data such as the curvature radius, the refractive power, the lens thickness, the lens focal length, the aspheric surface or the back focal length in this example are different from the optical data in the first example, and in this example, the first image-side surface 12 of the first lens element 10 has a concave part 16D in the vicinity of the optical axis and a convex part 17D in a vicinity of its circular periphery; the second object-side surface 21 of the second lens element 20 has a convex part 23D in the vicinity of the optical axis and a convex part 24D in a vicinity of its circular periphery. The optical data of the sixth example of the optical imaging lens set are shown in FIG. 26 while the aspheric surface data are shown in FIG. 27. The length of the optical imaging lens set is 4.868 mm. The image height is 2.856 mm, HFOV is 36.00 degrees. Some important ratios of the sixth example are as follows:

ALT=2.664

AAG=0.871

BFL=1.333

BFL/AAG=1.531

AG 12+34/T2=1.000

T3/AAG=0.950

T3/T4=0.800

T4/T2=4.157

AAG/T1=1.573

AAG/T4=0.842

ALT/T1=4.812

ALT/T4=2.576

AAG/T2=3.501

ALT/AG12+34=10.705

AAG/AG12+34=3.500

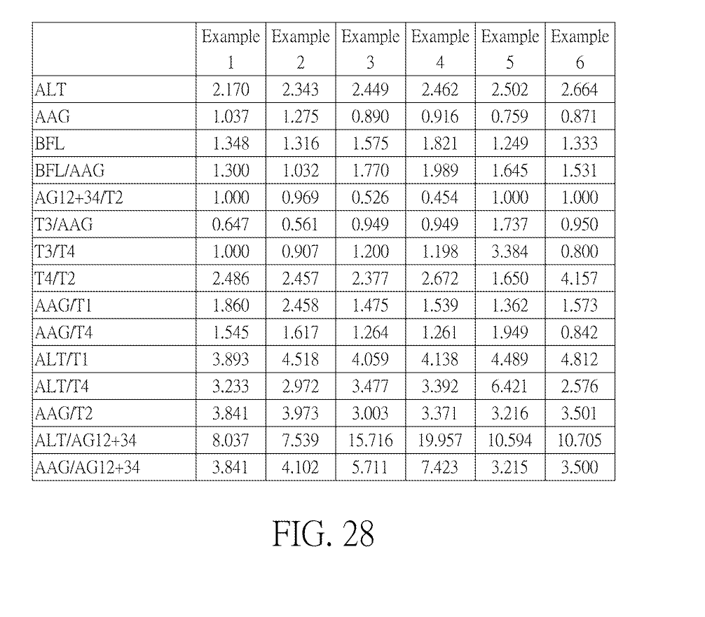

Some important ratios in each example are shown in FIG. 28.

In the light of the above examples, the inventors observe the following features:

1.Take the first embodiment as an example, in FIG. 2A, the curves of different wavelength are very close to each other, which means all of the off-axis light is focused on the vicinity of the imaging point, and the deviation between each off-axis light and the imaging point is ±0.05 mm, so the spherical aberration has been improved significantly. Besides, since the different curves are close to each other, the imaging positions of different wavelengths are close to each other too, improving chromatic aberration.

2. As shown in FIG. 2B and FIG. 2C, the focus in the whole view region of three different wavelengths is between ±0.1 mm, which means the optical imaging lens set of the first embodiment can eliminate the aberrations effectively. Furthermore, the distance between the curves is very small, meaning that the dispersion on the axis has greatly improved too. Please refer to FIG. 2D. The distortion aberration of the first embodiment is maintained in the range of ±0.5%, which means it has achieved the quality requirements of the imaging optical system, compared to conventional optical imaging lens sets; the present invention overcomes chromatic aberration and provides better image quality, furthermore, the total length of the optical imaging lens set is shortened to only about 4.5 mm . In summary, the first embodiment of the present invention has larger HFOV, but still maintains good optical performance.

3. The third lens element has positive refractive power, to provide the needed refractive power for the optical imaging lens set; the seconds lens element has negative refractive power, to fix the chromatic aberration. In addition, the first object-side surface of the first lens element has a convex part in a vicinity of the optical axis, and a convex part in a vicinity of its circular periphery, helping to collect the light. The third object-side surface of the third lens element has a concave part in a vicinity of its circular periphery, and the third image-side surface of the third lens element has a convex part in a vicinity of the optical axis; The fourth object-side surface of the fourth lens element has a convex part in a vicinity of its circular periphery, the fourth image-side surface of the fourth lens element has a concave part in a vicinity of the optical axis and a convex part in a vicinity of its circular periphery, where each of the surfaces match to each other, in order to improve the aberration.

In addition, the inventors discover that there are some better ratio ranges for different data according to the above various important ratios. Better ratio ranges help the designers to design the better optical performance and an effectively reduced length of a practically possible optical imaging lens set. For example:

BFL/AAG≦2.0; AAG/T1≧1.3; AAG/T2≧2.7; AAG/T4≦1.7; AAG/(AG12+AG34)>3.0: (4.1)

AAG is the sum of all three air gaps between each lens element from said first lens element to said four lens element along the optical axis, namely, AAG=AG12+AG23+AG34, if AAG is decreased, the total length of the optical image lens set can be shrunk. However, AG3 is an air gap between said second lens element and said third lens element along the optical axis, since the second lens element has negative refractive power, if AG23 can be maintained in a slightly larger value, it can help to converge the incident light to the fifth lens element, increasing the image quality. Therefore, AG23 should preferably be large. In addition, AG12 and AG34 can't be unlimitedly shrunk, and if AG23 become larger, AAG will become larger too. Therefore, BFL/AAG will become smaller, AAG/T1, AAG/T2, AAG/T4 and AAG/(AG12+AG34) will become smaller. In summary, if the relationship BFL/AAG≦2.0 is satisfied, it is suggested that the range may preferably be 0.8˜2.0; If the relationship AAG/T1≧1.3 is satisfied, it is suggested that the range may preferably be 1.3˜3.0; If the relationship AAG/T2≧2.7 is satisfied, it is suggested that the range may preferably be 2.7˜5.0; If the relationship AAG/T4≦1.7 is satisfied, it is suggested that the range may preferably be 0.7˜1.7; If the relationship AAG/(AG12+AG34)>3.0 is satisfied, it is suggested that the range may preferably be 3.0˜8.0.

(AG12+AG34)/T2≦1.0; ALT/(AG12+AG34)≧7.0: (4.2)

As mentioned above, AG12 and AG34 should preferably be small, so (AG12+AG34)/T2 should preferably be small, and ALT/(AG12+AG34) should preferably be large. In summary, if the relationship (AG12+AG34)/T2≦1.0 is satisfied, it is suggested that the range may preferably be 0.4˜1.0; If the relationship ALT/(AG12+AG34)≧7.0 is satisfied, it is suggested that the range may preferably be 7.0˜25.0.

T4/T2≧1.6; T3/T4≦1.2; ALT/T1≧3.45; ALT/T4≦3.8 : (4.3)

T1, T2, T3 and T4 are the thickness of the first lens element, the second lens element, the third lens element and the fourth lens element along said optical axis respectively. ALT=T1+T2+T3+T4. T1˜T4 should be maintained in a suitable range, for avoiding the total length of the lens set becoming too long if the air gaps are too big, as well as avoiding the assembling difficulties if the air gaps are too small. In summary, if the relationship T4/T2≧1.6 is satisfied, it is suggested that the range may preferably be 1.6˜5.0; If the relationship T3/T4≦1.2 is satisfied, it is suggested that the range may preferably be 0.6˜1.2; If the relationship ALT/T1≧3.45 is satisfied, it is suggested that the range may preferably be 3.45˜5.0; If the relationship ALT/T4≦3.8 is satisfied, it is suggested that the range may preferably be 2.0˜3.8.

(4.4) T3 AAG should be preferably smaller than 0.95, for avoiding T3 being too large and affecting the total length of the optical image lens set. If the relationship T3 AAG≦0.95 is satisfied, it is suggested that the range may preferably be 0.5˜0.95.

The optical imaging lens set 1 of the present invention may be applied to a portable electronic device. Please refer to FIG. 14. FIG. 14 illustrates a first preferred example of the optical imaging lens set 1 of the present invention for use in a portable electronic device 100. The portable electronic device 100 includes a case 110, and an image module 120 mounted in the case 110. A mobile phone is illustrated in FIG. 16 as an example, but the portable electronic device 100 is not limited to a mobile phone.

As shown in FIG. 14, the image module 120 includes the optical imaging lens set 1 as described above. FIG. 14 illustrates the aforementioned first example of the optical imaging lens set 1. In addition, the portable electronic device 100 also contains a barrel 130 for the installation of the optical imaging lens set 1, a module housing unit 140 for the installation of the barrel 130, a substrate 172 for the installation of the module housing unit 140 and an image sensor 70 disposed at the substrate 172, and at the image side 3 of the optical imaging lens set 1. The image sensor 70 in the optical imaging lens set 1 may be an electronic photosensitive element, such as a charge coupled device or a complementary metal oxide semiconductor element. The image plane 71 forms at the image sensor 70.

The image sensor 70 used here is a product of chip on board (COB) package rather than a product of the conventional chip scale package (CSP) so it is directly attached to the substrate 172, and protective glass is not needed in front of the image sensor 70 in the optical imaging lens set 1, but the present invention is not limited to this.

To be noticed in particular, the optional filter 72 may be omitted in other examples although the optional filter 72 is present in this example. The case 110, the barrel 130, and/or the module housing unit 140 may be a single element or consist of a plurality of elements, but the present invention is not limited to this.

Each one of the six lens elements 10, 20, 30, 40 with refractive power is installed in the barrel 130 with air gaps disposed between two adjacent lens elements in an exemplary way. The module housing unit 140 has a lens element housing 141, and an image sensor housing 146 installed between the lens element housing 141 and the image sensor 70. However in other examples, the image sensor housing 146 is optional. The barrel 130 is installed coaxially along with the lens element housing 141 along the axis I-I′, and the barrel 130 is provided inside of the lens element housing 141.

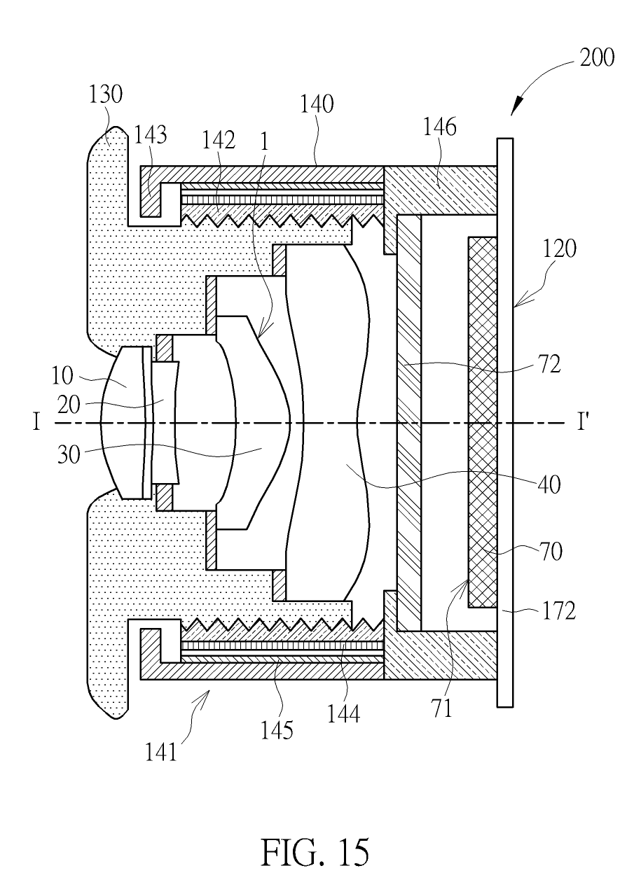

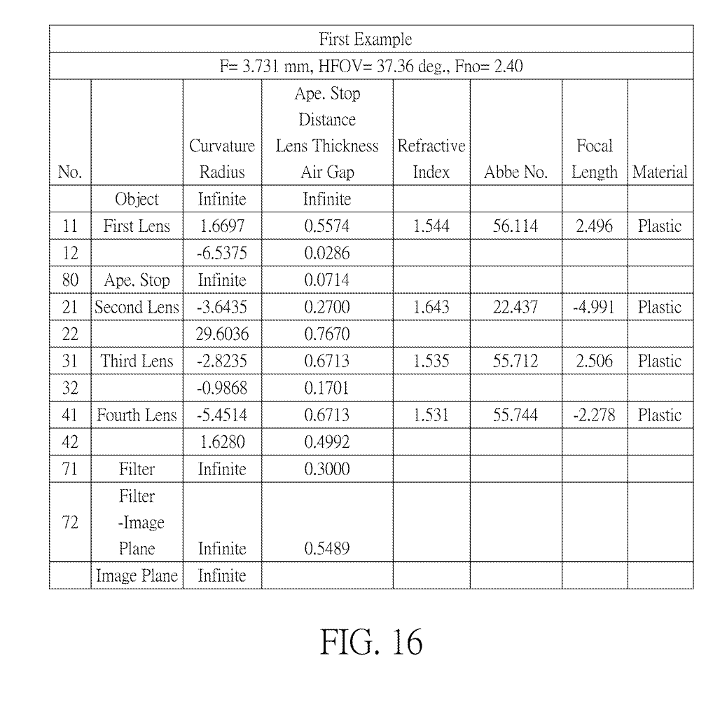

Please also refer to FIG. 15 for another application of the aforementioned optical imaging lens set 1 in a portable electronic device 200 in the second preferred example. The main differences between the portable electronic device 200 in the second preferred example and the portable electronic device 100 in the first preferred example are: the lens element housing 141 has a first seat element 142, a second seat element 143, a coil 144 and a magnetic component 145. The first seat element 142 is for the installation of the barrel 130, exteriorly attached to the barrel 130 and disposed along the axis I-I′. The second seat element 143 is disposed along the axis I-I′ and surrounds the exterior of the first seat element 142. The coil 144 is provided between the outside of the first seat element 142 and the inside of the second seat element 143. The magnetic component 145 is disposed between the outside of the coil 144 and the inside of the second seat element 143.

The first seat element 142 may pull the barrel 130 and the optical imaging lens set 1 which is disposed inside of the barrel 130 to move along the axis I-I′, namely the optical axis 4 in FIG. 1. The image sensor housing 146 is attached to the second seat element 143. The filter 60, such as an infrared filter, is installed at the image sensor housing 146. Other details of the portable electronic device 200 in the second preferred example are similar to those of the portable electronic device 100 in the first preferred example so they are not elaborated again.

Those skilled in the art will readily observe that numerous modifications and alterations of the device and method may be made while retaining the teachings of the invention. Accordingly, the above disclosure should be construed as limited only by the metes and bounds of the appended claims.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging lens set, from an object side toward an image side in order along an optical axis comprising: a first lens element, an aperture stop, a second lens element, a third lens element and a fourth lens element, all of the first lens element, the second lens element, the third lens element and the fourth lens element having refractive power, said first to fourth lens elements having an object-side surface facing toward the object side as well as an image-side surface facing toward the image side, wherein:
the first lens element having an object-side surface with a convex part in a vicinity of the optical axis, and with a convex part in a vicinity of its periphery;
the second lens element with negative refractive power;
the third lens element with positive refractive power, having an object-side surface with a concave part in a vicinity of its periphery, and having an image-side surface with a convex part in a vicinity of the optical axis;
the fourth lens element having an object-side surface with a convex part in a vicinity of its periphery, and having an image-side surface with a concave part in a vicinity of the optical axis, and a convex part in a vicinity of its periphery; and
the optical imaging lens set not including any lens element with refractive power other than said first lens element, second lens element, third lens element and fourth lens element.

2. The optical imaging lens set of claim 1, wherein a distance BFL between the image-side surface of the fourth lens element to an image plane along the optical axis, and the sum of all three air gaps AAG between each lens element from said first lens element to said fourth lens element along the optical axis satisfy a relationship BFL/AAG≦2.0.

3. The optical imaging lens set of claim 2, wherein an air gap AG12 between said first lens element and said second lens element along said optical axis, an air gap AG34 between said third lens element and said fourth lens element along said optical axis, and a thickness T2 of said second lens element along said optical axis satisfy a relationship (AG12+AG34)/T2≦1.

4. The optical imaging lens set of claim 3, wherein a thickness T4 of said fourth lens element along said optical axis satisfies a relationship 1.6≦T4/T2.

5. The optical imaging lens set of claim 3, wherein a thickness T1 of said first lens element along said optical axis satisfies a relationship 1.3≦AAG/T1.

6. The optical imaging lens set of claim 2, wherein a thickness T3 of said third lens element along said optical axis, and a thickness T4 of said fourth lens element along said optical axis satisfy a relationship T3/T4≦1.2.

7. The optical imaging lens set of claim 1, wherein a thickness T3 of said third lens element along said optical axis, and the sum of all three air gaps AAG between each lens element from said first lens element to said fourth lens element along the optical axis satisfy a relationship T3/AAG≦0.95.

8. The optical imaging lens set of claim 7, wherein an air gap AG12 between said first lens element and said second lens element along said optical axis, an air gap AG34 between said third lens element and said fourth lens element along said optical axis, and a thickness T2 of said second lens element along said optical axis satisfy a relationship (AG12+AG34)/T2≦1.

9. The optical imaging lens set of claim 8, wherein a thickness T4 of said fourth lens element along said optical axis satisfies a relationship AAG/T4≦1.7.

10. The optical imaging lens set of claim 8, wherein a total thickness ALT of said first lens element, said second lens element, said third lens element and said fourth lens element along said optical axis, and a thickness T1 of said first lens element along said optical axis satisfy a relationship 3.45≦ALT/T1.

11. The optical imaging lens set of claim 1, wherein an air gap AG12 between said first lens element and said second lens element along said optical axis, an air gap AG34 between said third lens element and said fourth lens element along said optical axis, and a thickness T2 of said second lens element along said optical axis satisfy a relationship (AG12+AG34)/T2≦1.

12. The optical imaging lens set of claim 11, wherein a total thickness ALT of said first lens element, said second lens element, said third lens element and said fourth lens element along said optical axis, and a thickness T4 of said fourth lens element along said optical axis satisfy a relationship ALT/T4≦3.8.

13. The optical imaging lens set of claim 12, wherein the sum of all three air gaps AAG between each lens element from said first lens element to said fourth lens element along the optical axis satisfies a relationship 2.7≦AAG/T2.

14. The optical imaging lens set of claim 1, wherein a thickness T3 of said third lens element along said optical axis, and a thickness T4 of said fourth lens element along said optical axis satisfy a relationship T3/T4≦1.2.

15. The optical imaging lens set of claim 14, wherein a total thickness ALT of said first lens element, said second lens element, said third lens element and said fourth lens element along said optical axis, an air gap AG12 between said first lens element and said second lens element along said optical axis, an air gap AG34 between said third lens element and said fourth lens element along said optical axis satisfy a relationship 7.0≦ALT/(AG12+AG34).

16. The optical imaging lens set of claim 15, wherein the sum of all three air gaps AAG between each lens element from said first lens element to said fourth lens element along the optical axis satisfies a relationship 3.0≦AAG/(AG12+AG34).

17. An electronic device, comprising:
a case; and
an image module disposed in said case and comprising:
an optical imaging lens set of claim 1;
a barrel for the installation of said optical imaging lens set;
a module housing unit for the installation of said barrel;
a substrate for the installation of said module housing unit; and
an image sensor disposed on the substrate and disposed at an image side of said optical imaging lens set.
